(19) United States
(12) Patent Application Publication
(10) Pub. No.: US 2006/0169146 A1
(43) Pub. Date: Aug. 3, 2006

(54) Filter structure of an industrial dust-collector

(76) Inventor: Kuo-Chin Cho, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/047,648

(22) Filed: Feb. 2, 2005

(51) Int. Cl. B01D 47/00

(52) U.S. Cl. 96/245

(57) ABSTRACT

A filter structure is provided in the liquid-collecting tank of an industrial dust-collector, and a floating ball and an air-exhausting exit are provided in the filter structure. The characteristic lies in that an air-tight non-hole section is provided at the upper end of the filter structure, the inner diameter of the airtight non-hole section is almost the same as that of the floating ball, and a meshed section is provided at the lower end of the filter structure.

### BACKGROUND OF THE INVENTION

1. Field of the Invention

The present invention relates to a filter structure of an industrial dust-collector with innovatory features, and more particularly to a filter structure which is provided with an airtight non-hole section at the upper end, and the inner diameter of the airtight non-hole section is almost the same as that of a floating ball in the filter structure, so as to effectively prevent liquid from entering the air-exhausting exit and to prolong the service life of the industrial dust-collector.

2. Brief Description of the Prior Art

The inventor of the present invention had filed application Ser. Nos. 10/420,793, 10/651,958, 10/683,402 to improve the functions of an industrial dust-collector.

Referring to FIGS. 1, 2 and 3, a main body 20 of a conventional industrial dust-collector is provided with a filter 201 in the interior. A floating ball 202 is provided in the filter 201. When liquid (industrial waste oils or chemical water) being sucked in the chamber 203 of the main body 20 and ascending to a certain height, the liquid will flow into the net holes 204 to force the floating ball 202 to ascend and seal up the air-exhausting exit 205, so as to prevent the liquid from flowing outward the air-exhausting exit 205.

However, there are following drawbacks in the above-described conventional filter of the industrial dust-collector

1. When the chamber 203 inside the main body 20 is filled with liquid, because the floating ball 202 can not fully seal up the air-exhausting exit 205, the liquid will easily flow outward to infiltrate the motor 206 and the fan 207.

2. Although the motor 206 is provided outside the dust-collector to prevent from liquid, the oil gas will still be sucked into the air-exhausting exit 205 by strong suction because the floating ball 202 does not fully seal up the air-exhausting exit 205.

3. The floating ball 202 will ascend according to the ascending liquid so that the liquid or oil gas will easily be sucked through the air-exhausting exit 205 and into the motor 206 and the fan 207, so as to cause damage to the machine and result in environmental pollution.

### SUMMARY OF THE INVENTION

Therefore, the objective of the present invention is to provide a filter structure of an industrial dust-collector that can substantially obviate the drawbacks of the related conventional filter of an industrial dust-collector.

An objective of the present invention is to provide a filter structure of an industrial dust-collector which is provided with an airtight non-hole section at the upper end.

Another objective of the present invention is to provide a filter structure whose floating ball can fully seal up the air-exhausting exit, so as to effectively prevent liquid from entering the air-exhausting exit and to prolong the service life of the industrial dust-collector.

Accordingly, a filter structure is provided in the liquid-collecting tank of an industrial dust-collector, and a floating ball and an air-exhausting exit are provided in the filter structure. The characteristic lies in that an air-tight non-hole section is provided at the upper end of the filter structure, the inner diameter of the airtight non-hole section is almost the same as that of the floating ball, and a meshed section is provided at the lower end of the filter structure.

### BRIEF DESCRIPTION OF THE DRAWINGS

Other features and advantages of the present invention will become apparent in the following detailed description of the preferred embodiments with reference to the accompanying drawings, in which:

FIG. 1 is a sectional view of a conventional industrial dust-collector in assembled configuration;

FIG. 2 is a schematic sectional view of a conventional filter of an industrial dust-collector in assembled configuration;

FIG. 3 is another schematic sectional view of a conventional filter of an industrial dust-collector in assembled configuration;

FIG. 4 is a schematic sectional view of the filter structure in accordance with the present invention being provided in an industrial dust-collector;

FIG. 5 is a sectional view of the filter structure in accordance with the present invention; and,

FIG. 6 is another sectional view of the filter structure in accordance with the present invention.

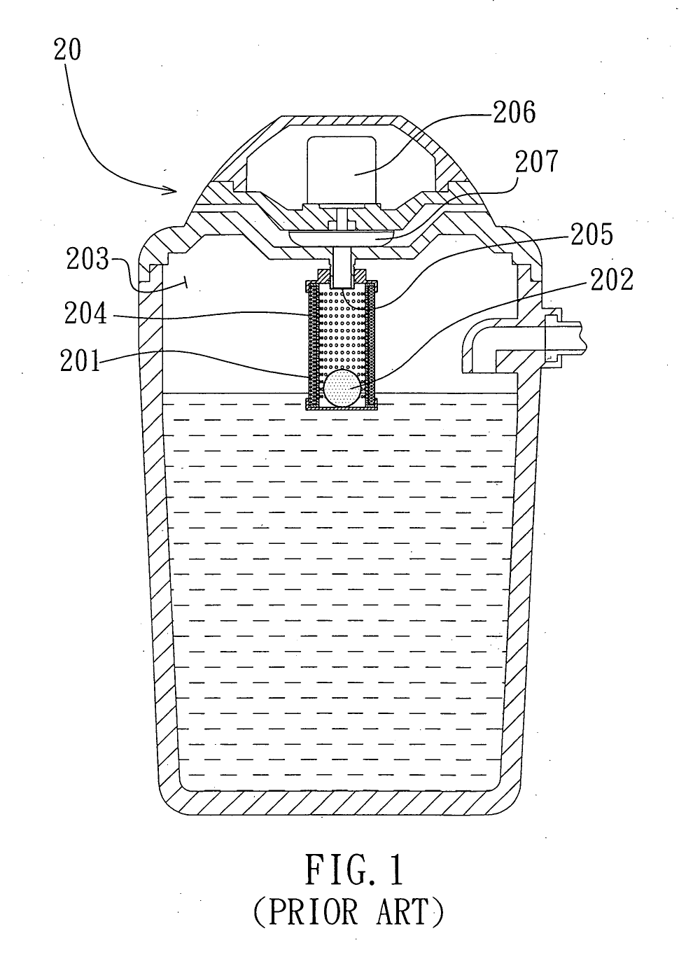

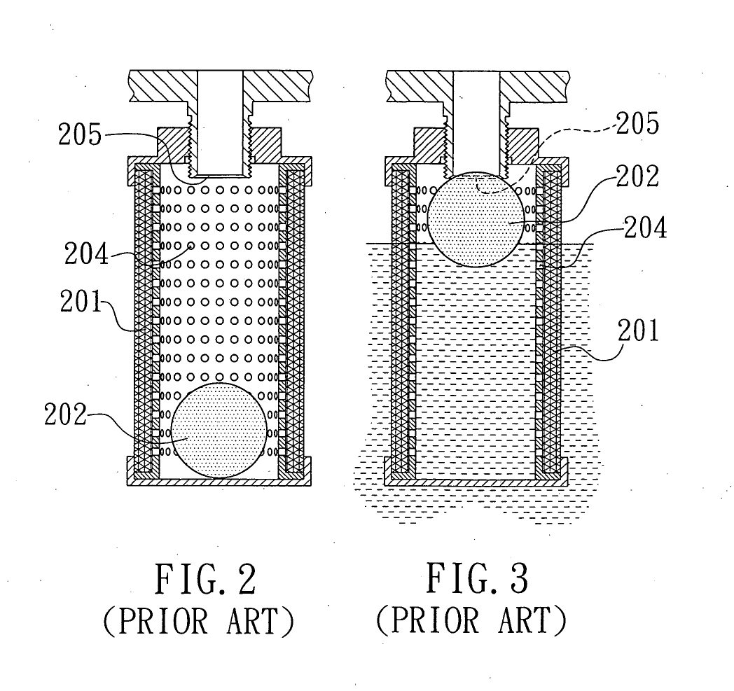

### DETAILED DESCRIPTION OF THE PREFERRED EMBODIMENTS

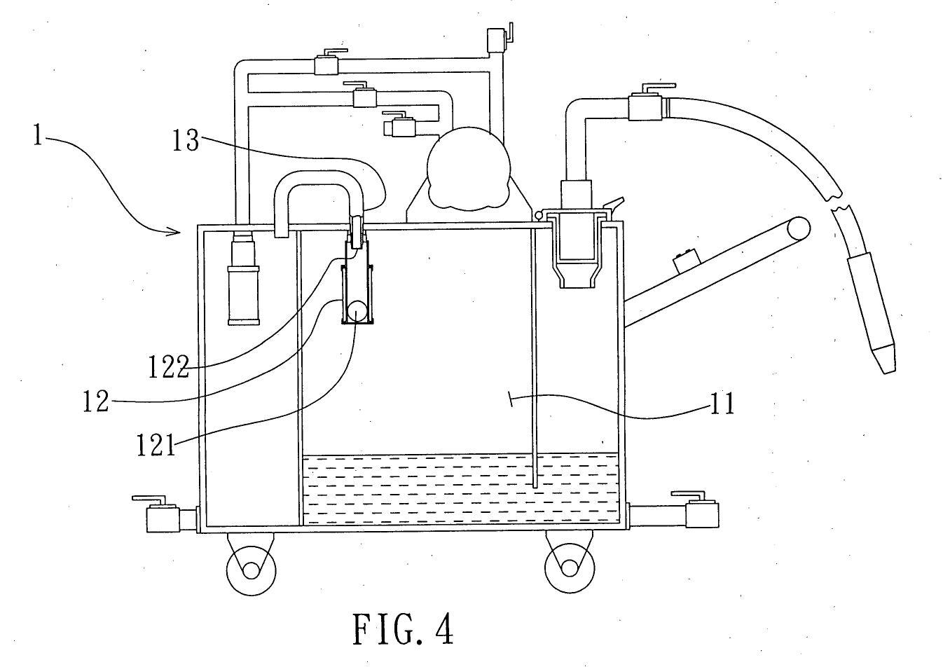

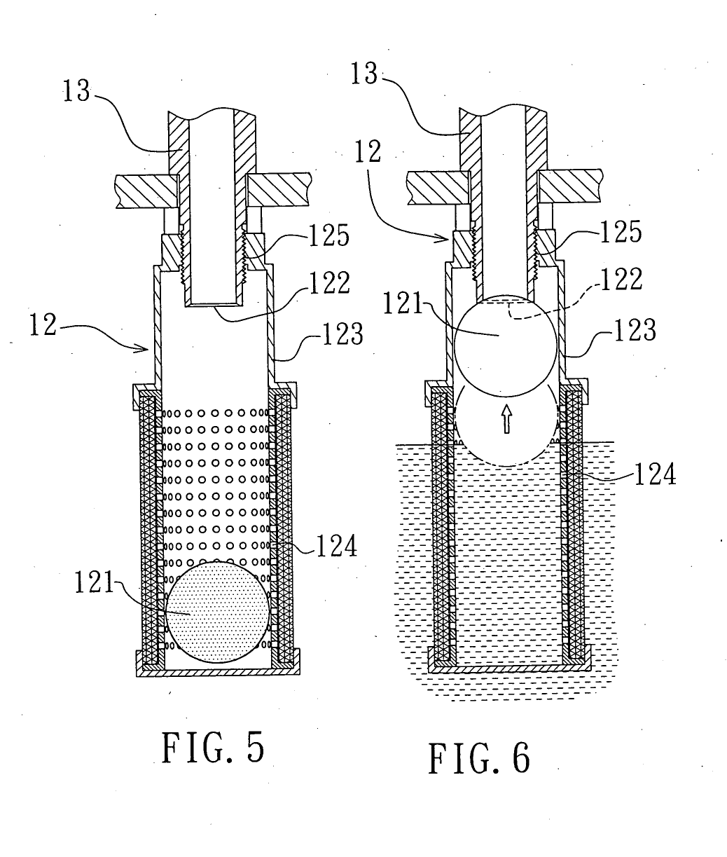

Referring to FIGS. 4 and 5, an embodiment of the filter structure 12 in the present invention is provided in the liquid-collecting tank 11 of the main body 1 of an industrial dust-collector, and a floating ball 121 and an air-exhausting exit 122 are provided in the filter structure 12. The characteristic lies in that an air-tight non-hole section 123 is provided at the upper end of the filter structure 12, the inner diameter of the airtight non-hole section 123 is almost the same as that of the floating ball 121, and a meshed section 124 is provided at the lower end of the filter structure 12.

A screwing section 125 is provided in the head portion to be screwed to the air-exhausting pipe 13.

While being operated, referring to FIGS. 5 and 6, when more and more liquid (industrial waste oil or chemical water) being sucked in the oil-collecting tank 11, the liquid will flow in the meshed section 124 of the filter structure 12 to force the floating ball 121 to ascend to approach the airtight non-hole section 123 of the filter structure 12. When the floating ball 121 touching the airtight non-hole section 123, gas is blocked by the surface of the floating ball 121 and can not enter, and the floating ball 121 will be sucked by the strong suction of the air-exhausting exit 122 to separate from the liquid and fully seal up the air-exhausting exit 122. Besides, because the inner diameter of the airtight non-hole section 123 is almost the same as that of the floating ball 121, few gas will flow through the space between the floating ball 121 and the inner wall of the airtight non-hole section 123, so as to effectively prevent oil gas from entering the air-exhausting exit 122 and to prolong the service life of the industrial dust-collector.

While the preferred embodiments of the invention have been described above, it will be recognized and understood that various modifications may be made therein, and the appended claims are intended to cover all such modifications which may fall within the spirit and scope of the invention.

What is claimed is:

1. A filter structure being provided in the liquid-collecting tank of the main body of an industrial dust-collector comprising
a floating ball being provided in said filter structure;
an air-exhausting exit being provided in said filter structure; and,
an air-tight non-hole section being provided at the upper end of said filter structure.

2. The filter structure of an industrial dust-collector as recited in claim 1, wherein the inner diameter of said airtight non-hole section is almost the same as that of said floating ball, and a meshed section is provided at the lower end of said filter structure.
